(19) United States
(12) Patent Application Publication
(10) Pub. No.: US 2009/0308811 A1
(43) Pub. Date: Dec. 17, 2009

(54) CHROMATOGRAPHY DEVICE

(75) Inventors: Frederick Tepper, Sanford, FL (US); Leonid A. Kaledin, Port Orange, FL (US); Tatiana Kaledin, Port Orange, FL (US)

Correspondence Address: COHEN & GRIGSBY, P.C., 625 LIBERTY AVENUE, PITTSBURGH, PA, 15222-3152, US

(73) Assignee: Argonide Corporation, Sanford, FL (US)

(21) Appl. No.: 12/482,585

(22) Filed: Jun. 11, 2009

Related U.S. Application Data
(60) Provisional application No. 61/060,549, filed on Jun. 11, 2008.

(51) Int. Cl. B01D 15/08

(52) U.S. Cl. 210/656; 210/198.2

(57) ABSTRACT

A chromatography device and method of use to separate components of a sample are described. The device includes a stationary phase supported by a frame or contained within a chamber in a housing. The stationary phase includes a nano alumina medium that has support fibers having nano alumina fibers attached thereto. Optionally, sorbents are electrostatically adhered to the nano alumina fibers. Chromatographic separations are effected by the mobile phase at pressures of less than 10 bar and at flow velocities up to at least 5 cm/min. An electrical potential can be applied across the medium to foster separation of components.

### CROSS-REFERENCE TO RELATED APPLICATIONS

This application claims priority to pending U.S. Provisional Patent Application No. 61/060,549 filed Jun. 11, 2008, which is incorporated herein in its entirety.

### BACKGROUND

Chromatography is one of the primary methods used to separate biological particles including viruses, bacteria, proteins, peptides and other molecules including nucleic acids, carbohydrates, fats, vitamins, and more. In general, chromatography involves moving a solution over a stationary phase to separate the components of the solution based on differences in characteristics such as structure and size. For example, low molecular weight components that are not sorbable by the stationary phase move through the stationary phase more quickly than macromolecules that have stronger interactions with the stationary phase.

Chromatographic separations are carried out using any of a variety of stationary phases, including immobilized silica on glass plates (thin layer chromatography), volatile gases (gas chromatography), paper (paper chromatography), and liquids that incorporate particles such as silica or resin (liquid chromatography). Electrophoresis is a form of chromatography where particles are separated under the influence of an implied electrical field.

Chromatography may account for as much as 40% of the cost of manufacturing pharmaceuticals. Much of the high cost of analysis and manufacture is due to the fact that a great deal of this processing uses high pressure liquid chromatography (HPLC), which is a multi-step process that utilizes packed columns and that requires that the columns be equilibrated prior to the sample being loaded onto the column. The components of the sample are eluted from the column and those of interest are collected in multiple fractions. The column is then cleaned, sterilized and recalibrated back to the starting conditions. The cost of the columns makes them too expensive to be disposable.

Conventional HPLC, a principal method for separating biological particles, uses a permanent phase of ultrafine adsorbent particles such as porous silica or resin spheres with particle sizes down to about 1 micron. Speed and resolution are two competing performance factors in conventional chromatography using these porous media. One feature is often achieved by sacrificing the other. Conventional wisdom focuses on surface area as the defining element for “dynamic capacity” when determining product throughput employing such chromatographic media.

In order to achieve flow through a bed of particles that are only 1 micron in size, the particles must be selected to have a very narrow particle size range to minimize clogging of the bed. Then these particles must be carefully packed into a cylindrical tube. High pressures, often on the order of several hundred bars, are required to achieve a reasonable flow through the packed column. These columns are not considered to be disposable because of the high cost of preparing the column. Unfortunately, the pore size of 1 micron granular sorbents is too small to allow entry of macromolecules such as large proteins and virus (up to 0.25 microns), let alone an active bacteria.

The separation of molecules that are soluble in aqueous or polar solution is also often slow and expensive. Transverse separation schemes such as paper chromatography, thin layer chromatography and high performance thin layer chromatography are used for assaying the radiochemical purity of radiopharmaceuticals, for determination of the pigments in a plant, for analyzing dyes and for monitoring organic reactions.

### SUMMARY OF THE INVENTION

In an embodiment, a chromatography column comprising a housing and a stationary phase is disclosed. The housing has an inlet, an outlet, and a chamber positioned therebetween. The stationary phase is contained within the chamber and includes a nano alumina medium that comprises support fibers having attached thereto nano alumina fibers. The support fibers have a diameter that is greater than that of the nano alumina fibers.

In another embodiment, a chromatography column comprising a housing, a support means, and a stationary phase is disclosed. The housing has an inlet, an outlet, and a chamber positioned therebetween. There is a support means within the chamber. The stationary phase is contained within the chamber and wrapped around the support means. The stationary phase includes a nano alumina medium that comprises support fibers having attached thereto nano alumina fibers. The support fibers have a diameter that is greater than that of the nano alumina fibers.

In another embodiment, a chromatography device is disclosed. The device comprises a frame and a stationary phase support by the frame. The stationary phase includes a nano alumina medium that comprises support fibers having attached thereto nano alumina fibers. The support fibers have a diameter that is greater than that of the nano alumina fibers. Optionally, the device further comprises a means for conducting an electrical current across the stationary phase.

In another embodiment, a method of chromatographic separation of a sample is disclosed. The method comprises the step of placing a sample into a chromatography column that has a nano alumina medium that comprises support fibers having attached thereto nano alumina fibers. The support fibers have a diameter that is greater than that of the nano alumina fibers. The method also comprises the steps of passing a mobile phase or eluent through the chromatography column and eluting the separated components from the nano alumina medium. Optionally, the method further comprises the step of applying a voltage across the stationary phase to foster separation of components.

These and other details, objects, and advantages of the disclosed chromatography column and method of chromatographic separation will become better understood or apparent from the following descriptions, examples, and figures showing embodiments thereof.

### BRIEF DESCRIPTION OF THE FIGURES

FIG. 1 is a cross-sectional view of one embodiment of the chromatography column.

FIG. 2 is a cross-sectional view of another embodiment of the chromatography column.

FIG. 3 is a cross-sectional view of another embodiment of the chromatography column.

FIG. 4 is a top plan view of the stationary phase contained within the chamber of the chromatography column.

FIG. 5 is a cross-sectional view of an embodiment of a chromatography device.

FIG. 6 is a transmission electron micrograph of the nano alumina medium.

FIG. 7 is a transmission electron micrograph of the nano alumina medium having nano silica particles electrostatically adhered to the nano alumina fibers.

FIG. 8 is a graphical depiction showing the effluent concentration of MS2 virus particles removed from the nano alumina medium as a function of the elutant volume. MS2 virus particles were loaded onto a single layer of the medium and then were removed by elution with a beef extract/glycine eluent.

FIG. 9 is a graphical depiction showing the percent of MS2 virus particles removed from the nano alumina medium as a function of the elutant volume. MS2 virus particles were loaded onto a single layer of the medium and then were removed by elution with a beef extract/glycine eluent.

FIG. 10 is a graphical depiction showing the effluent concentration of α3 and MS2 virus particles removed from the nano alumina medium as a function of the elutant volume. Virus particles were loaded onto a single layer of the medium and then were removed by elution with a beef extract/glycine eluent.

FIG. 11 is a graphical depiction showing the effluent concentration of α3 and MS2 virus particles removed from the nano alumina medium as a function of the elutant volume. Virus particles were loaded onto six layers of the medium and then were removed by elution with a beef extract/glycine eluent.

FIG. 12 is graphical depiction showing the effluent concentration of α3 and MS2 virus as a function of the elutant volume. Virus particles were loaded onto twelve layers of the medium and then were removed by elution with a beef extract/glycine eluent.

FIG. 13 is a graphical depiction showing the separation and concentration of Klebsiella terrigena (KT) and MS2 virus particles removed from the nano alumina medium as a function of the elutant volume. Bacteria and virus particles were loaded into the nano alumina medium and were then removed by elution with a beef extract/glycine eluent.

FIG. 14 is a graphical depiction showing the effluent concentration of MS2 virus particles removed from the nano alumina medium as a function of the elutant volume. MS2 virus particles were loaded onto three layers of the medium and then were removed by elution with a 0.25M Na₂CO₃ solution.

FIG. 15 is a graphical depiction showing the effluent concentration of α3 and MS2 virus particles removed from the nano alumina medium as a function of the elutant volume. Virus particles were loaded onto six layers of the medium and then were removed by elution with a 0.25M Na₂CO₃ solution.

FIG. 16 is a graphical depiction showing the effluent concentration of torula yeast RNA removed from the nano alumina medium as a function of the elutant volume. RNA was loaded onto a single layer of the medium and then was removed by elution with a Na₂CO₃ solution.

FIG. 17 is a graphical depiction of showing the effluent concentration of α3 and MS2 virus particles removed from the nano alumina medium including 28 wt % nano silica particles as a function of the elutant volume. Virus particles were loaded onto six layers of the medium and then were removed by elution with a beef extract/glycine eluent.

FIG. 18 is a graphical depiction showing the effluent concentration of α3 and MS2 virus particles removed from the nano alumina medium including 30 wt % nano titania particles as a function of elutant volume. Virus particles were loaded onto six layers of the medium and then were removed by elution with a beef extract/glycine eluent.

### DETAILED DESCRIPTION

### Definitions

In order to properly understand the disclosure of the claimed invention, certain terms used herein are described in the following paragraphs. While the inventors describe the following terms, the inventors in no way intend to disclaim the ordinary and accustomed meanings of these terms.

The term “aspect ratio” as used herein is defined as the ratio of the longitudinal length of a fiber to the cross-sectional diameter of the fiber.

The term “lyocell” as used herein refers to a fibrillated cellulose fiber precipitated from an organic solution in which no substitution of hydroxyl groups takes place and no chemical intermediates are formed.

The term “nano alumina” as used herein is defined as nano alumina fibers having an aspect ratio in excess of about 5, where the smallest dimension is less than about 50 nm. The cross section of the fiber may be either circular (cylindrical fiber) or rectangular (platelet) in shape. The fibers are comprised of alumina, with various contents of combined water to result in compositions principally made up of AlOOH and that include varied amounts of Al(OH)₃, with possible impurities of gamma and alpha alumina.

A “nano particle” is defined as a particle having an average size that is less than about 0.1 μm.

“Paper” or “paper-like” is defined to be a generally flat, fibrous layer or mat of material formed by a wet laid process.

A “particle” is defined as a solid that ranges from a few nanometers to colloidal and sub-micron, with no limitation on shape. “Particle” includes molecules that are dissolved in an aqueous or polar fluid.

The term “zeta potential” as used herein is the potential difference between the eluent and the stationary phase. The potential is pH dependent.

### Description of Embodiments

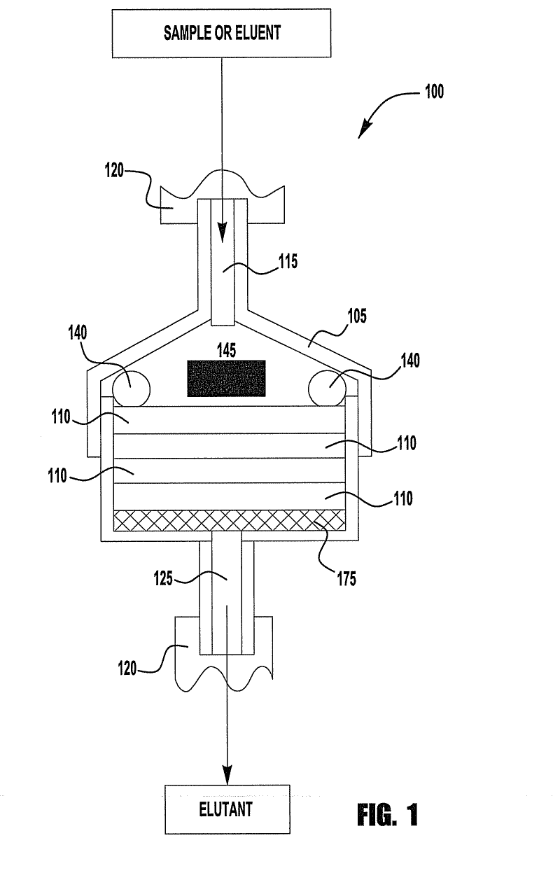

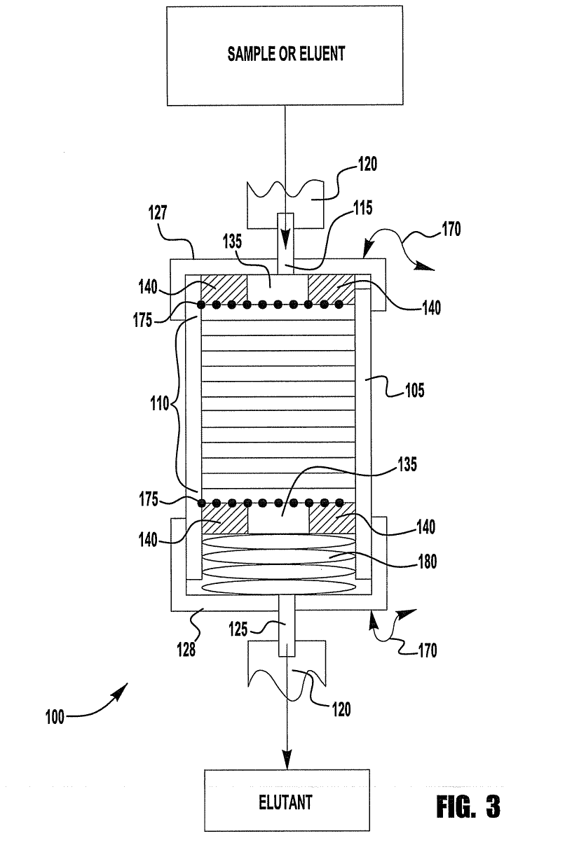

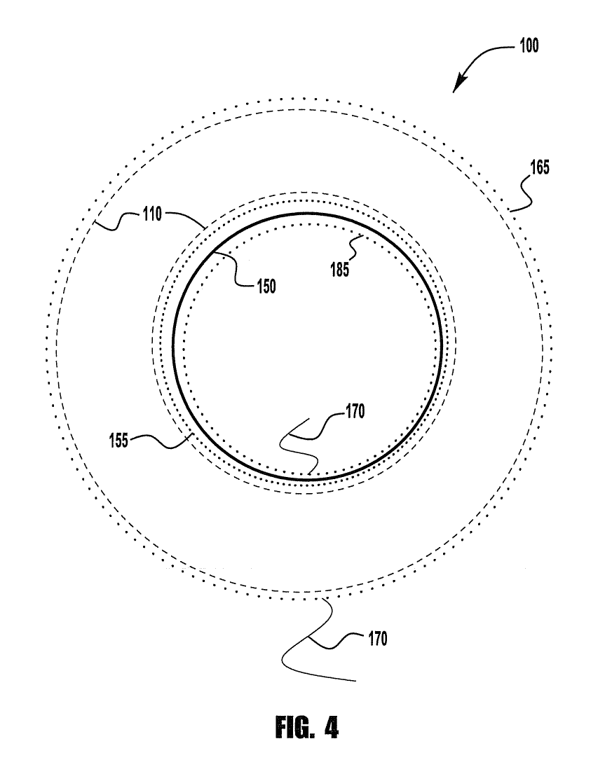

Embodiments of the chromatography column 100 are shown in FIGS. 1-4. The chromatography column 100 is suitable for use in displacement chromatography (FIG. 1), low pressure liquid chromatography (not shown), elution chromatography (not shown), paper chromatography (not shown), electrophoresis (FIGS. 3, 4), thin layer chromatography (not shown), and high performance thin layer chromatography (not shown). In examples, the chromatography column 100 is used to separate components of a sample, including cell debris and contaminants having low molecular weights, viruses, bacteria, peptides, proteins, oligonucleotides, and nano-sized particles such as virus and plasmid DNA. In an example, the chromatography column 100 is disposable.

As shown in FIGS. 1-4, in an embodiment, the column 100 comprises a housing 105 and a stationary phase 110. The housing 105 can be fabricated from any suitable non-conductive material, including plastics such as polyethylene, polycarbonate, or polypropylene. The housing 105 has an inlet 115 for receiving a liquid such as a sample or mobile phase and placing the liquid into the column 100. The inlet 115 interfaces with a connector 120 that is configured to connect to tubing, a luer-lock fitting, or the like. The housing 105 has an outlet 125 for releasing the elutant from the column 100. The outlet 125 interfaces with a connector 120 that is configured to connect to tubing, a luer-lock fitting, or the like, for connection to a detector or a collection container (not shown). See FIGS. 1-3. There is void between the inlet 115 and the stationary phase 110 and the stationary phase and the outlet 125 to allow fluid to flow through the column.

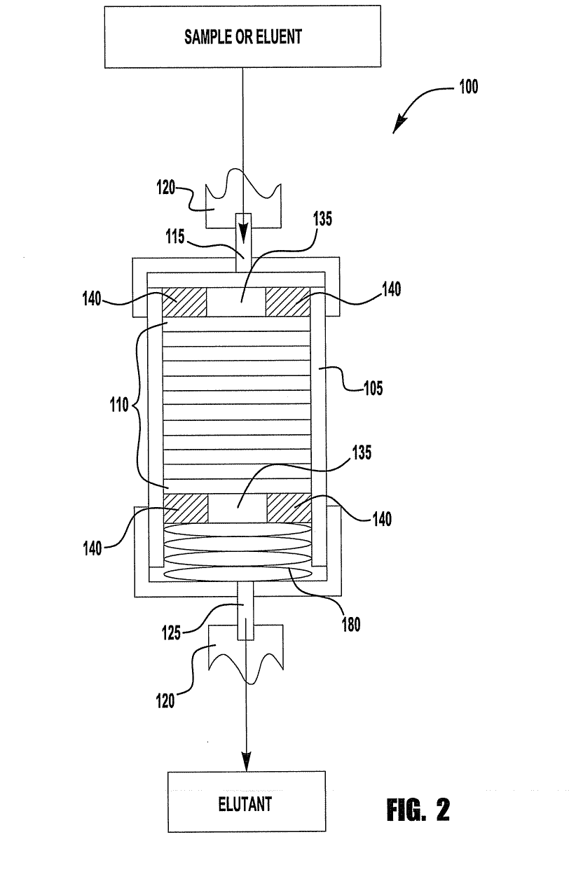

A chamber 145 is positioned between the inlet 115 and outlet 125. In an example, the chamber 145 is cylindrical. The chamber 145 contains the stationary phase 110 that forms a fluid-tight seal with the interior walls of the chamber 145. Optionally, there is a spring 180 (FIGS. 2, 3) or a seal 140, such as an O-ring (FIG. 1) or a gasket (FIGS. 2, 3), a stainless steel wire mesh (FIG. 1), a porous polymer plug (not shown) or the like, that is positioned within the chamber 145 to compress the layers of the stationary phase together to minimize or essentially eliminate air gaps between the layers of medium (described below), that maintains a fluid-tight seal between the inlet 115 and the stationary phase 110 and/or the stationary phase 110 and the outlet 125. See FIGS. 1-3.

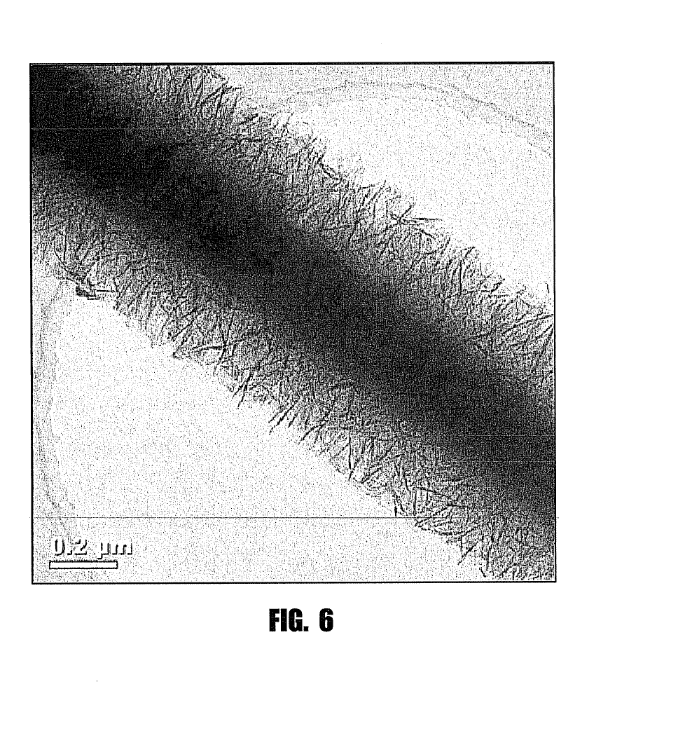

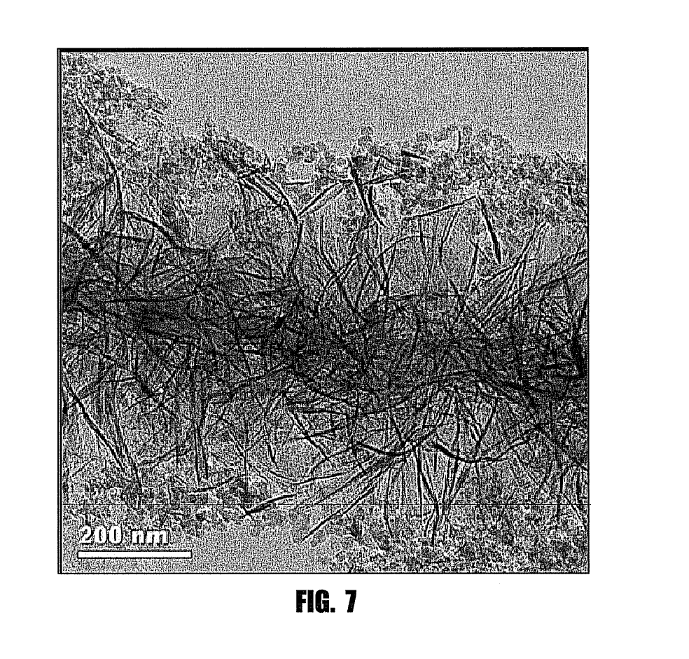

The stationary phase 110 includes a non-woven nano alumina medium that comprises support fibers having attached thereto electropositive nano alumina fibers. In examples, the support fibers are microglass or lyocell. The support fibers have a diameter greater than that of the nano alumina fibers. In an example, the nano alumina fibers have a diameter of about 2 nm and a surface area of up to about 500 m²/g. Optionally, the support fibers include a mixture of small (about 0.25 μm to about 0.6 μm) and large (about 1.5 μm to about 3 μm) diameter fibers. The inclusion of large diameter fibers in the support medium results in the formation of pore sizes in the medium of up to about 50 μm, which are large enough to permit passage and separation of components having diameters up to about 50 μm, such as bacteria. The nano alumina fibers are generally attached to the support fibers such that the nano alumina fibers are on the exterior of the medium, thereby making them highly accessible to attract and bind negatively charged particles that pass through the medium. Accordingly, when the mobile phase (described below) is passed through the stationary phase 110 even at a pressure of less than about 1 bar, the stationary phase 114 yields a high resolution. Operation at these pressures results in differential binding of particles or molecules to the nano alumina medium and differential separation by the eluent. The medium 110 is effective at a pH from about 4 to about 10. This pH range can be expanded to about 3 to about 11 where the column is disposable. For example, at a pH of about 7, the nano alumina/microglass medium has a charge of about +50 mV. Transmission electron micrographs of examples of stationary phases 110 are shown in FIGS. 6, 7. In the example shown in FIG. 6, the support fibers are microglass. In the example shown in FIG. 7, the support fibers are microglass and nano silica particles (described below) are electrostatically adhered to the nano alumina fibers.

Optionally, the nano alumina medium further comprises sorbent particles electrostatically adhered to the nano alumina fibers to alter the degree of attachment of particles and molecules passing through the stationary phase. Examples of sorbent particles include nano-size metal oxides such as nano goethite or manganese oxide, manganese hydroxide, nano silica, or nano titania. See, FIG. 7. In other examples, the sorbent particles are biological particles such as proteins, peptides, nucleic acids, antibodies, or antigens. In other examples, the sorbent particles are negative ions such as phosphates or sulfates.

FIG. 4 shows a top plan view of the stationary phase 110 contained within the chamber of an embodiment of the chromatography column 100. The stationary phase 110 that includes the nano alumina medium is arranged in a spiral wound configuration around a perforated mandrel 150 to facilitate flow through the medium. Optionally, as shown, there is a conductive perforated tube 185 positioned adjacent to the mandrel 150 to facilitate conduction of an electrical potential across the medium 100. In another example, the mandrel 150 is conductive, thereby eliminating the need for the inner conductive perforated tube 185. Optionally, there is at least one layer of scrim 155 wrapped around the mandrel 150 between the mandrel 150 and the nano alumina medium 110 in order to provide strength to the nano alumina medium 110 wrap. In the example shown in FIG. 4, there are multiple layers of nano alumina medium 110. Optionally the outer layer has larger pore sizes than the inner layer of medium 110 such that it serves as a prefilter to remove coarse particulates from the sample. In examples, the pore size of the outer layer ranges from about 8 μm to about 20 μm and that of the inner layer ranges from about 1.5 μm to about 5 μm. The mandrel 150, scrim 155, and layers of nano alumina medium 110 are inserted into a perforated, conductive cartridge 165 that is configured to be contained by the housing 105. In examples, electrodes 170 are attached to the conductive cartridge 165 and/or mandrel 150 for use in electrophoresis, as described below.

Optionally, the nano alumina medium further comprises third fibers such as cellulose, microfibrillated cellulose such as lyocell, or bicomponent polymers. The outer layer of the bicomponent third fiber partially fuses with the nano alumina medium, thereby increasing the strength of the nano alumina medium and making it more flexible.

In examples, the nano alumina medium 110 is produced by high-speed paper making technology as a non-woven handsheet or by air laying the medium. In an embodiment, the nano alumina medium 110 is cut into discs that are positioned in the chamber 145 of the housing 105. Optionally, the stationary phase 110 includes a plurality of layers or pieces of nano alumina medium stacked in the chamber 145. See FIGS. 1-3. In other examples, the medium 110 is wrapped around a support means 150 axially positioned within the chamber 145. See FIG. 4.

Optionally, the chromatography column 100 is configured for attachment to two leads 170 for use in electrophoresis. In an example where the housing is an insulator such as polypropylene, one lead 170 contacts an electrode through a metal cap 127 on the inlet 115 side and a second lead 170 contacts an electrode 175 through a metal cap 128 on the outlet 125 side. Electrodes include, for example, conductive wire mesh 175 (FIG. 3), a conductive perforated tube 185 (FIG. 4), a conductive gasket (FIG. 3), or the like.

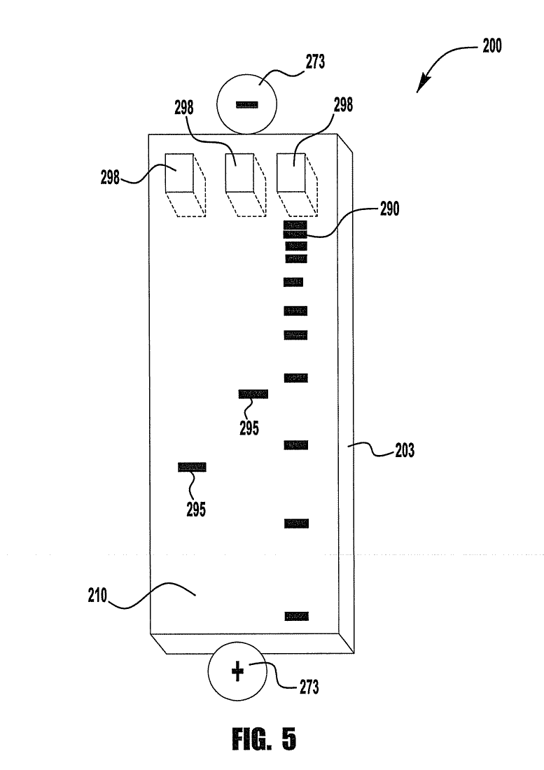

In another embodiment, shown in FIG. 5, the chromatography device 200 is used in electrophoresis to separate components of a sample 295. The chromatography device 200 comprises a frame 203 and a stationary phase 210. The 203 frame can be fabricated from any suitable non-conductive material, including plastics such as polyethylene, polycarbonate, or polypropylene.

The stationary phase 210 is supported by the frame 203. As described above, the stationary phase 210 includes a non-woven nano alumina medium that comprises support fibers having attached thereto electropositive nano alumina fibers. Also as described above, the nano alumina medium 210 has sorbent particles electrostatically adhered to the nano alumina fibers. Third fibers such as those described above may also be included in the nano alumina medium 210. At least two wells 298 are formed in the stationary phase. One well 298 is configured for injection of a known standard and the remaining slots 298 are configured for injection of sample 295. In use, the stationary phase 210 is wetted with the eluent and a current is applied by the current source 273 that causes the mobile phase to move toward the positive anode and separation of the components of the sample, as shown by the bands 290, 295 in FIG. 5.

In another embodiment, a method of chromatographic separation of a sample into separate components is disclosed. In examples, the method is used to identify compounds making up a sample. In other examples, the method is used to separate biological materials such as viruses, bacteria, peptides, proteins, oligonucleotides, DNA, or RNA in a sample. In other examples, the method is used to separate dyes using thin layer chromatography techniques. In examples, the method of chromatographic separation is useful for assaying the radiochemical purity of radiopharmaceuticals, determining pigments in a plant, detecting pesticides or insecticides in food, analyzing the dye composition of fibers in forensics, identifying compounds present in a given substance, and monitoring organic reactions.

The method comprises the step of placing a sample into the chromatography column described above. The sample is placed or loaded into the column at flow velocities ranging from about 0.1 cm/min to about 5 cm/min and at a pressure drop ranging from about 0.1 bar to about 10 bar. Sample volume may be limited by such factors as the diameter or width of the stationary phase.

After the sample is loaded into the column, the mobile phase or eluent is passed through the column to sequentially elute components of the sample from the column. The eluent is an aqueous solution such as saline or pure water or a solution of serum such as bovine serum albumin or beef extract and glycine, a polar organic solvent such as an alcohol or glycol. Separation may be enhanced by the addition of an inorganic salt solution such as sodium chloride, a carbonate salt solution such as sodium carbonate, a bicarbonate salt solution such as potassium bicarbonate, a phosphate salt solution such as sodium phosphate or a sulfate salt solution such as sodium sulfate. In other examples, the eluent includes particles such as proteins or nucleic acids that displace the adsorbed molecule or particle from the stationary phase. Variations in the concentration and pH of the eluent result in variations in separation factors. The mobile phase or eluent is passed through the column at a flow velocity of greater than about 0.1 cm/min to about 5 cm/min and at a pressure of about 0.1 bar to about 10 bar. Separation increases as flow velocity decreases. Additionally, longer columns require greater pressure. Separations of components making up the sample passed through the stationary phase is possible within about a minute to several minutes rather than tens of minutes or hours required for separation using conventional stationary phases.

Next, the separated components are eluted off of the medium. Optionally, separation of components of the sample is fostered by application of a voltage across the stationary phase.

In an example, the sample is placed into the column in a first direction and the eluent is passed through the column in the same direction. In another example, the sample is placed into the column in a first direction and the eluent is passed through the column in a second direction that is opposite to the first direction.

### EXAMPLES

The following examples illustrate several embodiments of the claimed chromatography column. These examples should not be construed as limiting.

### Example 1

### Formation of Nano Alumina Medium

Slurries of nano alumina medium were prepared by dispersing 6 g of microglass fibers (Lauscha Fiber International, borosilicate glass, grade B-06-F, 0.6 μm diameter) in 0.75 L of permeate from a reverse osmosis water generator using a kitchen style blender (12 speed Osterizer blender) on a “low-clean” setting for 1 minute. Aluminum powder (1.8 g; Atlantic Equipment Engineers, grade AL-100, 1-5 μm) was added to the microglass fibers such that after the reaction the solids consisted of 40 parts AlOOH and 60 parts microglass fibers. Two slurries of 750 mL were prepared. Ammonium hydroxide (8 ml of 36% per 750 ml of slurry) was added to initiate the reaction of aluminum powder with water to form the AlOOH and hydrogen. The mixture was heated to and maintained at boiling until the mixture was milky white. Then the mixture was cooled and neutralized to approximately pH 7 using hydrochloric acid. FIG. 6 shows a transmission electron micrograph of the nano alumina medium.

Handsheets (12″×12″) of the nano alumina medium were prepared and 25 mm discs were cut out of the handsheet. Unless otherwise noted, all examples described below used 25 mm discs (surface area ˜3.7 cm²) that were approximately 0.8 mm thick.

### Example 2

### Formation of Nano Alumina Medium Loaded with Nanopowders

In this example, either 4.3 g of TiO₂ or 3.9 g of SiO₂ dry nanopowders were added to the slurries prepared in Example 1 above to produce about 30% TiO₂ or about 28% SiO₂, respectively, particulate powder loading. The zeta potentials were +31±4 mV for 30% nano titania and +56±6 mV for 28% nano silica. FIG. 7 shows a transmission electron micrograph of nano alumina medium having nano silica particles having a diameter of about 10 nm electrostatically adhered to the nano alumina fibers.

SiO₂ is electronegative at a pH greater than about 2 and therefore it was expected that its zeta potential would be more negative when the SiO₂ was added to the nano alumina fibers. Surprisingly, the zeta potential was actually more electropositive when the SiO₂ was added to the nano alumina fibers. See Table 1. The nano alumina medium that includes nano silica particles provides a stationary phase that has more external surface area than conventional stationary phases that include 1 micron or larger silica beads.

### Example 3

### Formation of Nano Alumina Medium Including Nanopowders

A slurry of nano alumina medium was prepared as described in Example 2. After cooling, 10 mL of 28% ammonium hydroxide was added to the slurry, followed by 3.7 g FeCl₃*6H₂O dissolved in about 20-30 mL of RO water. The slurry was dried and inspected by high resolution transmission electron microscopy. A layer of FeOOH particles, with an approximate size of about 1-10 nm was electrostatically adhered to the nano alumina fibers. The adhesion of FeOOH to the nano alumina fibers can alter the retention factors for some biological particles in chromatographic separation.

Alternatively, 8.8 g of manganese chloride (MnCl₂*4H₂O) (Aldrich Chemical) was added to the slurry and the medium was prepared as described above (29% AlOOH, 28% MnO₂, 43% microglass).

### Example 4

### Formation of Nano Alumina Medium Including Potassium Phosphate or Potassium Sulfate

In examples, a slurry of nano alumina medium was prepared as described in Example 1. After cooling and adjusting the pH to about 7.4±0.2, 350 mL of either 0.1, 0.3, or 0.5 M KH₂PO₄ solution were added and the resulting slurries were stirred for about 60 hrs. The zeta potential for the medium modified with 0.5 M KH₂PO₄ was about −8.6±2 mV at pH 7. The negative zeta potential causes an electrostatic repulsive force between the negatively charged medium and negatively charged particles such as viruses, bacteria, proteins, nucleic acids, and the like. The repulsive forces are likely to cause desorption by overcoming other attractive forces (e.g., van der Waals).

In other examples, after cooling and adjusting the pH to 7.4±0.2, 350 mL of either 0.1, 0.3, or 0.5 M K₂SO₄ (Sigma) solution were added to the slurry and the resulting mixtures were stirred for about 60 hrs.

In other examples, 5% RNA (torulla yeast) was added to the slurry. The resulting medium had a zeta potential of about −5.7±4 mV at pH. The negative zeta potential causes an electrostatic repulsive force that is likely to cause desorption as described above.

### Example 5

### Elution of MS2 Viruses from the Nano Alumina Medium

This example was carried out to determine the effluent concentration of MS2 virus particles following removal of the virus from the stationary phase of the column by an eluent that included a solution of beef extract and glycine. The eluent was formed by dissolving 3 weight % beef extract (Beckton Dickinson and Co. Product #212303) in RO water containing 0.05 M glycine buffer (Sigma Aldrich Cat #410225). The pH of the eluent was adjusted to 7.4 with 1 M sodium hydroxide and the mixture was autoclaved at 121° C. for 30 min.

One disc of the nano alumina medium (prepared as described in Example 1) was placed into a filter holder (VWR part #28144-109) and MS2 viruses (size 27.5 nm) were adsorbed to the nano alumina medium by loading 10 mL of the virus solution into the medium at input concentrations of either 30 virus particles/mL or 54 virus particles/mL at a flow velocity of 5 cm/min and a pressure drop of 0.2 bar.

Elutions were performed by passing 3.25 mL of the eluent through the single layer of nano alumina medium at a flow velocity of 5 cm/min in the direction of flow opposite to that used to load the virus onto the medium and at a pressure drop of 0.2 bar. Five aliquots (0.25 mL each) followed by four aliquots (0.5 mL each) of elutant were collected. Collection of each 0.25 mL aliquot took an average of 0.75 seconds and collection of each 0.5 mL aliquot took an average of 1.5 sec. The concentration of MS2 virus in the elutant was assayed by the method of overlay agar along with a culture of E. coli (ATCC No. 15597) in the logarithmic phase of growth.

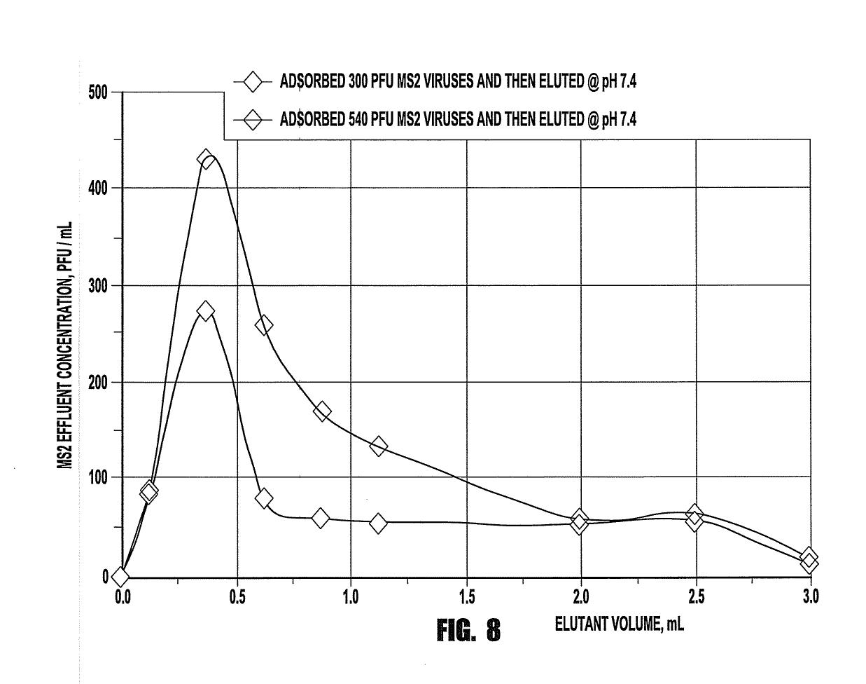

FIG. 8 is a graphical depiction showing the effluent concentration of MS2 virus particles removed from the medium as a function of the elutant volume. The data confirm that the nano alumina medium adsorbed the MS2 virus particles when the particles were loaded onto the medium because MS2 virus was present in the elutant following elution with the beef extract/glycine solution. As shown in FIG. 8, MS2 virus concentration peaked at about 0.37 mL of elutant for both input concentrations of MS2 virus, with the assay results showing a peak concentration of about 275 PFU/mL in the elutant when the medium was loaded with 30 virus particles/mL and about 435 PFU/mL in the elutant when the medium was loaded with 54 virus particles/mL.

The concentration of MS2 in the first 1 mL of extract was approximately 150 and 250 particles/mL for input concentrations of 30 and 54 virus particles/mL, respectively. The concentration factors achieved were 5.0 and 4.6, respectively, calculated as the ratio of input concentration (300 PFU/mL and 540 PFU/mL, respectively) to elutant concentration (150 PFU/mL and 250 PFU/mL, respectively).

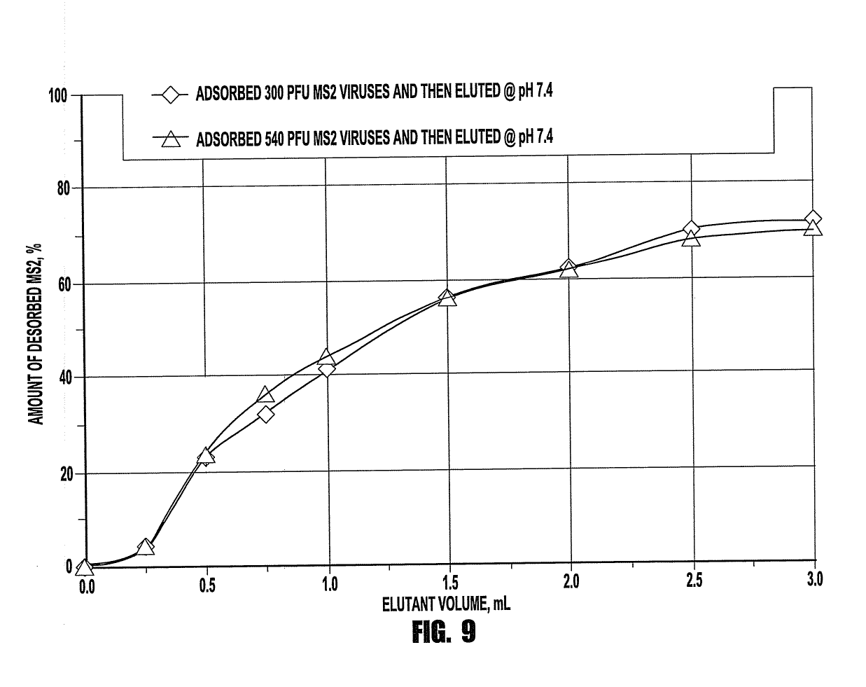

FIG. 9 is a graphical depiction showing the percent of MS2 virus particles removed from one layer of nano alumina medium as a function of the elutant volume. As shown in FIG. 9, about 70% of the virus that was loaded onto the column was removed from the column after elution with 3 mL of eluent.

### Example 6

### Elution and Separation of α3 and MS2 Virus Mixtures from the Nano Alumina Medium

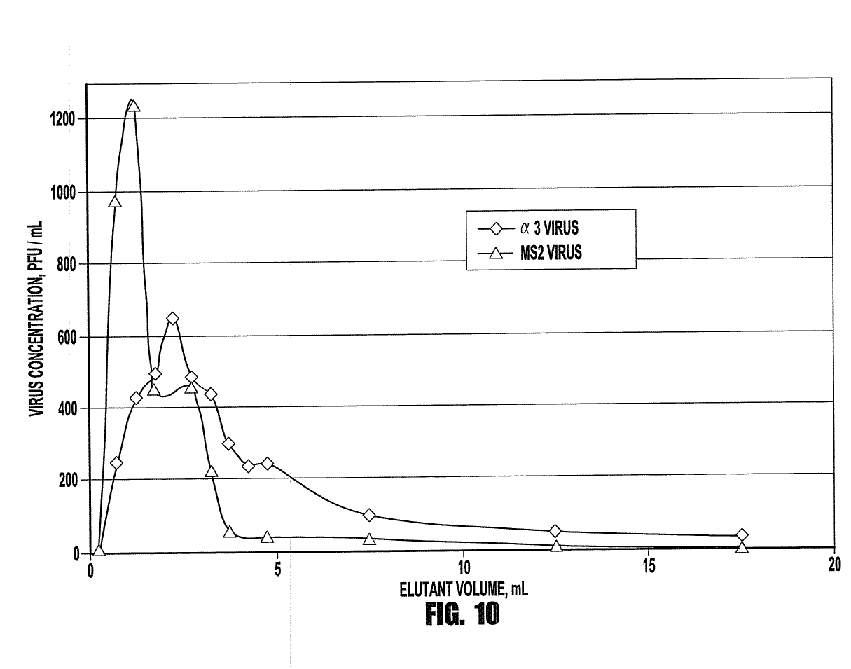

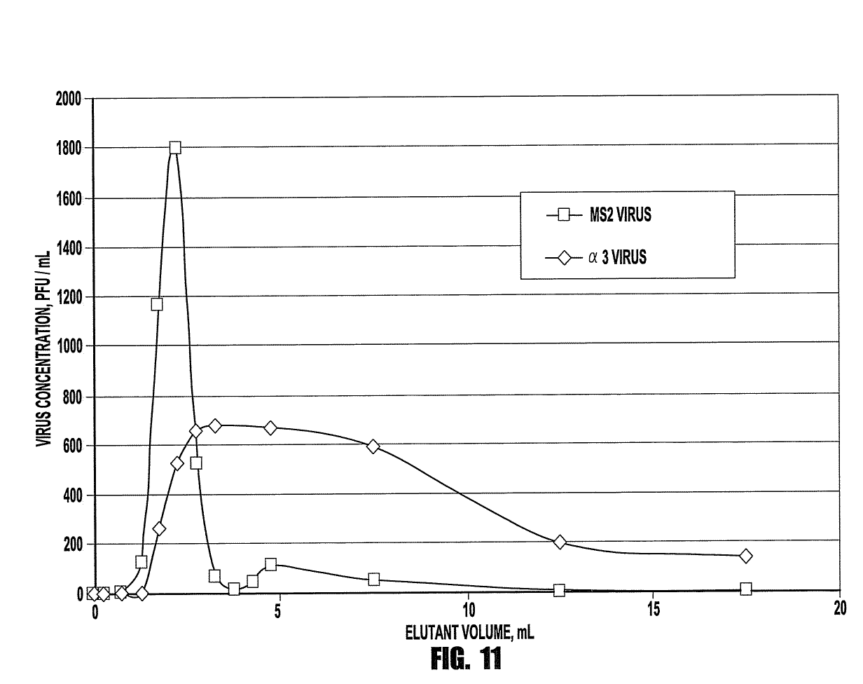

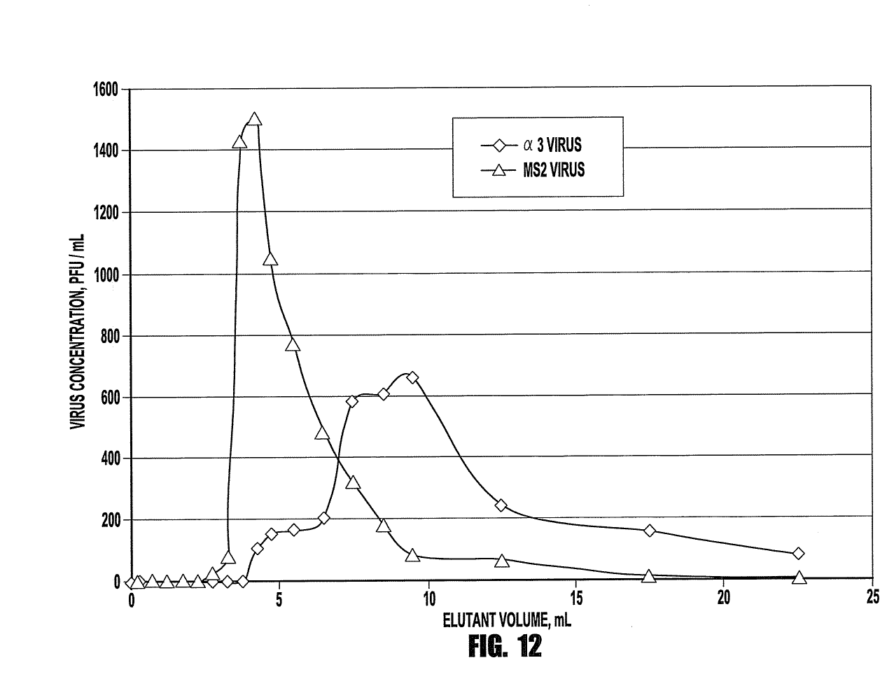

Discs of the nano alumina medium were prepared as described in Example 1. Either a single disc or stacks of discs having 3, 6, 12, or 24 layers of discs were loaded with a mixture of approximately equal quantities of MS2 and α3 viruses at input concentrations of about 10 to about 100 virus particles/mL at a flow velocity of 5 cm/min and at pressures of 0.1 bar (single layer), 0.2 bar (3 layers), 0.5 bar (6 layers), 1 bar (12 layers), or 2 bar (24 layers). The eluent was prepared as described in Example 5. Elutions were performed by passing eluent through either a single layer of the nano alumina medium (data not shown) or stacks of the nano alumina medium having 3 (FIG. 10), 6 (FIG. 11), 12 (FIG. 12), or 24 (data not shown) discs stacked together in filter holders (VWR part #28144-109). Ten aliquots (0.5 mL each) followed by three aliquots (5 mL each) of elutant were collected from columns having single, 3, or 6 layers of nano alumina medium. Twenty aliquots (0.5 mL each) followed by three aliquots (5 mL each) of elutant were collected from columns having 12 or 24 layers of nano alumina medium. Collection of each 0.5 mL aliquot took an average of 7.5 seconds and collection of each 5 mL aliquot took an average of 75 seconds. Elution was performed at a flow velocity of 1 cm/min in the same flow direction (forward flow) as the adsorption step at pressures of 0.1, 0.2, 0.5, 0.7, or 1 bar for samples eluted through 1, 3, 6, 9, or 12 or 24 layers of nano alumina medium, respectively. The slower flow velocity used in this Example (1 cm/min) compared to that used in Example 5 (5 cm/min) to improve virus resolution and to keep pressure at less than about 1 bar, even for columns having 12 layers of nano alumina medium.

The concentration of MS2 virus in the elutant was assayed as described as in Example 5. The concentration of α3 virus was assayed by the method of overlay agar along with a culture of E. coli strain C (ATCC No. 13706) in the log phase of growth. The data in FIGS. 10-12 show that the volume difference in peak concentrations of viruses removed from the nano alumina medium improves as a function of increasing numbers of layers of nano alumina medium.

### Example 7

### Elution and Separation of Bacteria and Virus Mixtures from the Nano Alumina Medium

Discs of the nano alumina medium were prepared as described in Example 1. The discs were loaded with a mixture of Raoultella terrigena bacteria deposited as Klebsiella terrigena (about 0.5 to about 1 microns, ATCC 33257) and MS2 virus at input concentrations of about 180

PFU/mL and 54 PFU/mL, respectively, at a flow velocity of 5 cm/min and 0.1 bar pressure.

The eluent was prepared as described in Example 5. Elutions were performed by passing the eluent through a single layer of the nano alumina medium. Elution was performed at a flow velocity of about 1 cm/min in the opposite flow direction as the adsorption step.

The concentration of MS2 virus in the elutant was assayed as described as in Example 5. The concentration of bacteria was assayed by performing a rapid (7-12 hrs at 36-38° C.) heterotropic plate count on prepoured and predried adsorbent agar plates.

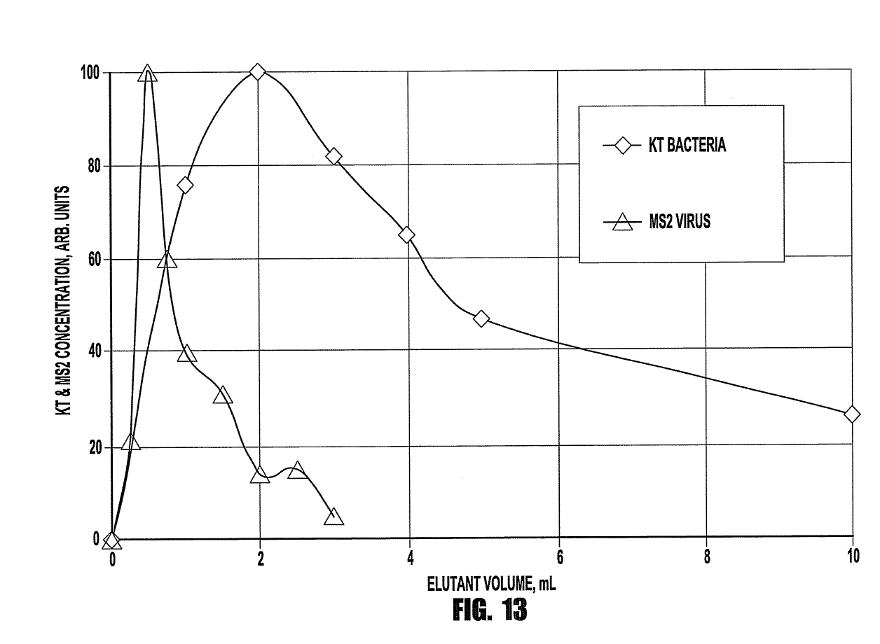

FIG. 13 is a graphical depiction showing the separation of KT bacteria (about 0.5 to about 1 μm diameter) and MS2 virus in the elutant and confirming that the eluent removed the bacteria and virus particles from the nano alumina medium. Twelve aliquots (0.25 mL each, average collection time 3.8 seconds each) followed by three aliquots (1.0 mL each, average collection time 15 seconds each) of elutant were collected. The data show that bacteria, which are too large to enter the pores of conventional silica or resin beads, can be separated from virus and other biological particles by chromatography using the nano alumina medium as the stationary phase.

### Example 8

### Elution of MS2 Viruses from Nano Alumina Medium Using 0.025 M Na₂CO₃ as the Eluent

Discs of the nano alumina medium were prepared as described in Example 1. The discs were loaded with 50 mL of MS2 virus at input concentrations of about 260 PFU/mL and at a flow velocity of 3 cm/min.

A solution of 0.025 M Na₂CO₃ was used as the eluent and was prepared by dissolving sodium carbonate (Na₂CO₃, Aldrich, Cat #22,232-1) in reverse osmosis purified water and then filtering the solution through a 0.45 μm membrane.

Elutions were performed by passing 0.5 mL aliquots of sodium carbonate solution at a flow velocity of 1 cm/min in the same flow direction as the adsorption step. The concentration of MS2 virus in the elutant was assayed as described as in Example 5.

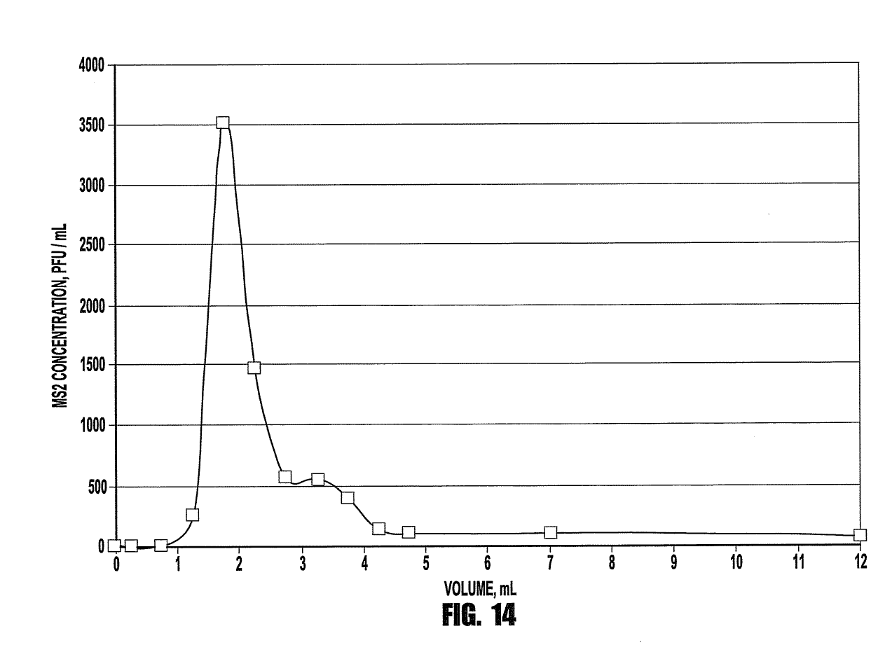

FIG. 14 is a graphical depiction showing the effluent concentration of MS2 virus particles removed from the medium by elution with Na₂CO₃ can be used to remove virus particles from the nano alumina medium. As shown, MS2 virus concentration peaked at about 2 mL of elutant, with the assay results showing a peak concentration of about 3500 PFU/mL in the elutant when the medium was loaded with virus particles. The concentration factor achieved was 13.5, calculated as the ratio of the input concentration (3500 PFU/mL) to elutant concentration (260 PFU/mL).

### Example 9

### Separation and Elution of MS2 and α3 Viruses from the Nano Alumina Medium Using 0.025 M Na₂CO₃ as the Eluent

Discs of nano alumina medium were prepared as described in Example 1. Either single discs (data not shown) or stacks of six discs were loaded with mixtures of MS2 and α3 viruses at input concentrations in the range of 100 to 500 virus particles/mL, and at a flow velocity of 3 cm/min. A solution of 0.025 M Na₂CO₃ was prepared as the eluent as described in Example 8. Elutions were performed by passing eluent at a flow velocity of 1 cm/min in the same flow direction as the adsorption step. Ten (0.5 mL each) aliquots of elutant, followed by three (5 mL each) aliquots, were collected. The concentrations of MS2 and α3 viruses in the elutant were assayed as described in Examples 4 and 5, respectively.

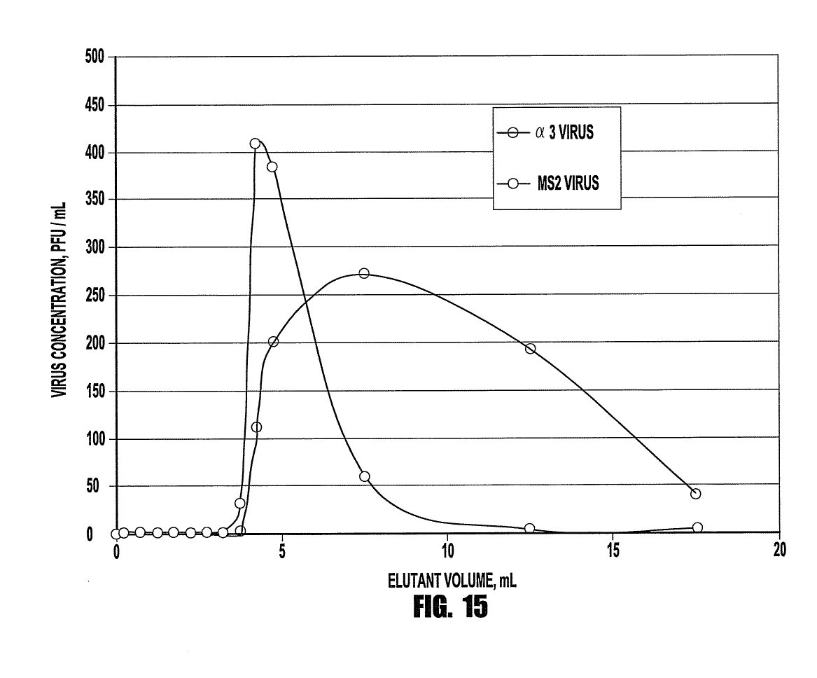

FIG. 15 is a graphical depiction showing the effluent concentrations of α3 and MS2 virus particles removed from the six layers of the medium by elution with Na₂CO₃ as a function of elutant volume. The data confirm that Na₂CO₃ can be used to separate the α3 and MS2 virus from each other after the viruses are loaded onto the medium, and further confirm that Na₂CO₃ can be used to remove the viruses from the medium. As shown, MS2 virus concentration in the elutant peaked at about 5 mL of elutant, with the assay results showing a peak concentration of about 410 PFU/mL in the elutant. α3 virus concentration in the elutant peaked at about 7 mL of elutant, with the assay results showing a peak concentration of about 275 PFU/mL in the elutant.

### Example 10

### Elution of RNA from the Nano Alumina Medium Using Na₂CO₃ as the Eluent

Discs of nano alumina medium were prepared as described in Example 1. A single disc was loaded with 5 mL of RNA solution (torula yeast, Sigma, Catalog #R6625) at an input concentration of 500 μg/mL and a flow velocity of 3 cm/min. Elutions were performed by passing five 2 mL aliquots of either 0.01 M, 0.025 M or 0.5 M solutions of Na₂CO₃ as the eluent through the single disc at a flow velocity of 1 cm/min and at a pressure drop of approximately 0.3 bar. The flow direction was opposite to that of the adsorption experiments.

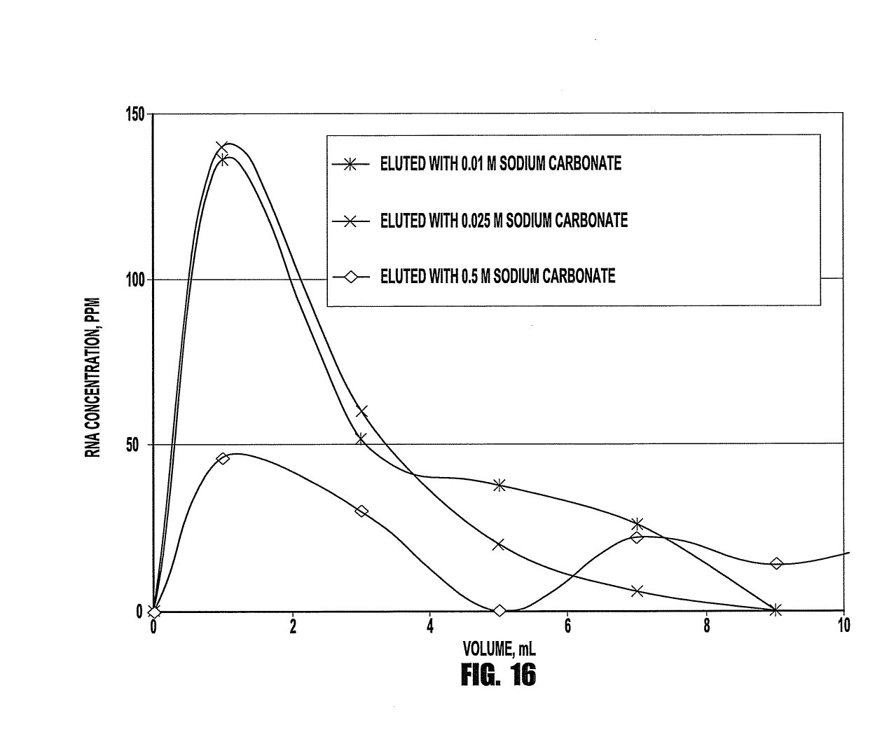

100 mL of elutant was added to 2 mL of blue fluorescent DAPI nucleic acid stain (Molecular Probes, fluoropure grade, 0.2 ppm) was added to the RNA in the elutant. The excitation maximum for DAPI bound to RNA is 358 nm and the emission maximum is 500 nm. It is known that the DAPI stain bound to dsDNA increases the resulting fluorescence signal by a factor of 20. Similar increases in the fluorescence signal are noted when the DAPI stain is bound to RNA molecules. The fluorescence signal of the elutant samples collected was measured with the use of a Hoefer TKO-100 fluorometer. Data shown in FIG. 16 are presented for 2 mL aliquots, with 0.1 mL being extracted from the aliquot for assay.

FIG. 16 is a graphical depiction showing the effluent concentrations of RNA removed from the nano alumina medium as a function of elutant volume. As shown, RNA concentration peaked at about 1 mL of elutant for each of the three concentrations Na₂CO₃ used as the eluent, indicating that elution of RNA from the medium is independent of Na₂CO₃ concentration.

### Example 11

### Separation of α3 and MS2 Virus Mixtures from Nano Alumina Medium Including Nano Titania Particles and Using Beef Extract/Glycine as Eluent

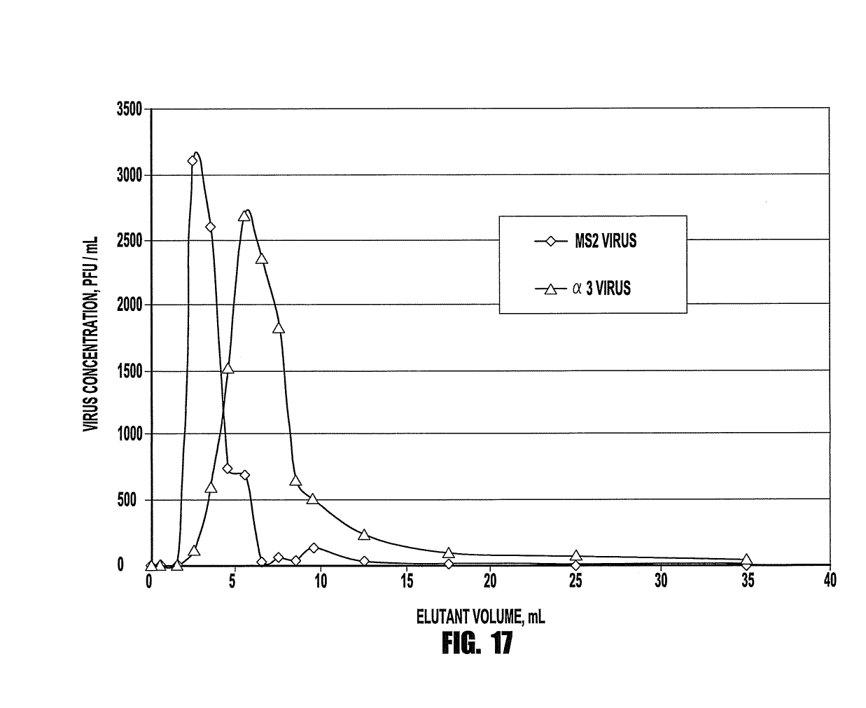

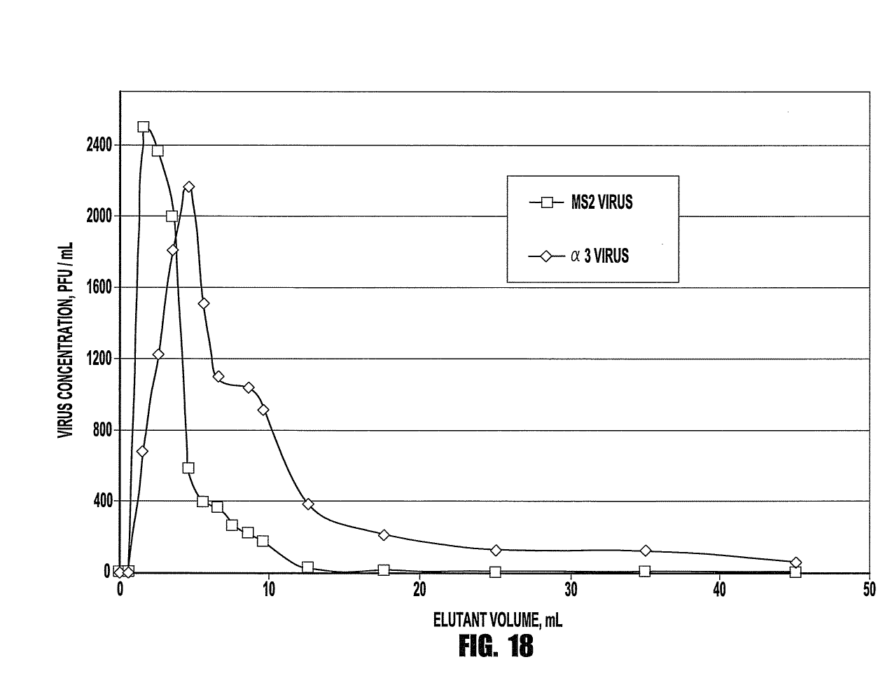

Six discs of nano alumina medium were prepared as described in Example 1 and were loaded with a mixture of approximately equal quantities of MS2 and α3 viruses at input concentrations in the range of about 10 to about 100 virus particles/mL at a flow velocity of 5 cm/min. Elutions were performed by passing beef extract and glycine solution at a flow velocity of 1 cm/min in the same flow direction (forward flow) as the adsorption step. Ten aliquots (0.5 mL each) followed by five aliquots (5 mL each) of elutant were collected. Data are shown in FIGS. 17 and 18.

FIG. 17 is a graphical depiction showing the effluent concentration of α3 and MS2 virus particles removed from the nano alumina medium that includes nano silica molecules as a function of elutant volume. As shown, virus concentration peaked at about 2.5 mL of elutant for the MS2 virus, at a concentration of about 3100 PFU/mL. Concentration for the α3 virus peaked at about 6 mL of elutant, at a concentration of about 2700 PFU/mL.

FIG. 18 is a graphical depiction of the effluent concentration of α3 and MS2 virus particles removed from nano alumina medium that includes nano titania particles as a function of elutant volume. As shown, virus concentration peaked at about 2.5 mL of elutant for the MS2 virus at a concentration of about 250 PFU/mL. Concentration for the α3 virus peaked at about 4.5 mL of elutant at a concentration of about 2200 PFU/mL.

The data shown in FIGS. 17 and 18, when compared to those shown in FIG. 11, suggest that inclusion of nano silica particles in the nano alumina medium does improve separation and elution of the virus particles, while there is less apparent improvement in separation when nano titania particles are included in the medium.

### Example 12

### Paper-Like Chromatography

Paper-like 10 cm×10 cm squares were cut from a sheet of nano alumina medium prepared as described in Example 1. Six drops of food dyes were added to 50 mL RO water or a solution of 0.002M inorganic dyes were prepared. The squares of nano alumina medium were immersed into the water. The separation of the dye was computed as R_{f} according to Equation [1]:

R_{f}=D_{dye}/Dₛₒₗᵥₑₙₜ [Equation 1]
where D_{dye} is the distance traveled by the dye from the application point and
Dₛₒₗᵥₑₙₜ is the distance traveled by the solvent from the application point. The higher the R_{f} value, the greater is the separation.

Table 1 provides R_{f} values obtained for various dyes. The data confirm that the nano alumina medium is capable of separating food and inorganic dyes. The pore size and zeta potential of the media affects the separation. The addition of nano silica and nano titania to the NC media does not show much, if any, effect on the separation of these dyes. Therefore, these data confirm that the nano alumina medium is useful in the analysis of complex mixtures including soluble dyes, amino acids, pesticides and other water soluble molecules.

TABLE 1
R_{f} values for separating dyes using nano alumina medium

| | | | R_{f} Value | | | | | |
|---|---|---|---|---|---|---|---|---|
| | Pore | Zeta | | Metanil | Brilliant | Food | Food | Food |
| | size, | potential | Methylene | yellow | yellow | dye | dye | dye |
| Media | μm | mV | blue dye | dye | dye | yellow | red | blue |
| Nano | ~2 | +50 | 0.19 | 0.25 | 0.28 | 0.83 | 0.45 | 0.77 |
| alumina | | | | | | | | |
| medium^{a} | | | | | | | | |
| Nano | ~2 | −8.3 | 0.0 | 0.48 | 0.39 | 1.0 | 0.85 | 0.35 |
| alumina | | | | | | | | |
| medium^{b} + | | | | | | | | |
| KH₂PO₄ | | | | | | | | |
| Nano | ~1.2 | +29 | 0.16 | 0.28 | 0 | 0.16 | 0.13 | 0.58 |
| alumina | | | | | | | | |
| medium^{c} | | | | | | | | |
| Nano | ~2 | +31 | 0.05 | 0 | 0 | 0 | 0 | 0 |
| alumina | | | | | | | | |
| medium^{d} + | | | | | | | | |
| nano TᵢO₂ | | | | | | | | |
| Nano | ~2 | +56 | 0 | 0 | 0 | 0 | 0 | 0 |
| alumina | | | | | | | | |
| medium^{d} + | | | | | | | | |
| nano SᵢO₂ | | | | | | | | |

Notes:
^{a}see Example 1;
^{b}See Example 4;
^{c}see Example 1, but prepared with lyocell;
^{d}see Example 2.

### Example 14

### Electrophoretic Separation of Dyes from Nano Alumina Medium

To accomplish electrophoretic separation of inorganic dyes, an electrophoretic cell was used that consisted of two filter holder bases (VWR part #28144-255) between which five discs of nano alumina medium were vertically stacked while the meshes were faced towards each other. The assembly was secured together. The meshes were connected with a 0.3 mm diameter stainless steel wire to a direct current (DC) power supply (Agilent, model E3612A, max current −0.5 A).

A 25 mm diameter disc of the nano alumina medium was dipped into a mixture of Metanil Yellow (concentration of 0.002 M) and Methanyl Blue (concentration of 0.002 M) dyes for one minute and then inserted together with 4 untreated discs of nano alumina medium (white color) into the fixture. The fixture was dipped into a 0.025 M NaOH solution and 30 volts at a current of 0.1 A was supplied to the meshes from the power supply for 10 minutes. The distance between a 25 mm diameter mesh electrodes was approximately 4 mm. Table 2 shows the results of dyes separation when the source disc (i.e., the disc dipped into dye) was placed in different positions in the stack of 5 discs with respect to the electrodes.

TABLE 2
Electrophoretic dye separation

| Electrode | Color of nano alumina medium | | | | | Electrode |
|---|---|---|---|---|---|---|
| Positive | Source | white | White | White | White | Negative |
| | disc | | | | | |
| | yellow | Source | White | White | White | |
| | | disc | | | | |
| | yellow | Yellow | Source | White | White | |
| | | | Disc | | | |
| | yellow | Yellow | Yellow | Source | White | |
| | | | | Disc | | |
| | white | yellow | Yellow | Yellow | Source | |
| | | | | | disc | |

These data demonstrate that Metanil Yellow was electrophoretically separated from the mixture as indicated by the change in color of the untreated discs of nano alumina medium from white to yellow. In the control experiment, in which no voltage was applied, there was no yellow staining on the white discs of nano alumina medium, indicating that the absence of power did not result in separation during ten minutes.

### Example 15

### Separation of Dyes from Nano Alumina Medium by Capillary Forces

To accomplish separation of water soluble dyes on the medium by capillary forces advancing the dyes at different rates, four untreated nano alumina discs (prepared as described in Example 1) and one nano alumina disc loaded with a mixture of inorganic dyes were vertically stacked into a filter holder (VWR part #28144-109). A 25 mm diameter disc of the nano alumina medium was dipped into a mixture of Metanil Yellow (concentration of 0.002 M) and Methanyl Blue (concentration of 0.002 M) dyes for one minute and then inserted into the middle of a stack of 4 discs (untreated) of nano alumina medium (white color) and into a filter holder (VWR part #28144-109). The fixture was dipped either into RO water or into a 0.025 M NaOH solution for 1, 5, or 25 hours. Table 3 shows the results of dyes separation.

TABLE 3
Capillary forces dye separation on nano alumina medium

| | Time, | | | | | |
|---|---|---|---|---|---|---|
| Carrier | hrs | Color | | | | |
| RO water | | Lower disc 2 | Lower | Source disc | Upper | Upper disc 2 |
| | | | disc 1 | | disc 1 | |
| | 1 | white | green | ″ | Blue | white |
| | 5 | very light blue | blue | ″ | Blue | very light blue |
| | 25 | light blue | blue | ″ | Blue | blue |
| 0.025 M NaOH | 1 | white | blue | ″ | Blue | white |
| | 5 | very light blue | Blue | ″ | Blue | very light blue |
| | 25 | very light blue | blue | ″ | Blue | very light blue |

These data demonstrate that Methanyl Blue was separated by capillary forces from the mixture as indicated by the change in color of the untreated discs of nano alumina medium from white to blue.

The examples presented above demonstrate that a chromatography device that has nano alumina medium as its stationary phase is capable of separating and concentrating biological particles at high flowrates and at pressure drops of less than 1 bar. Moreover only a few layers of media are required to achieve effective separation of one biological particle from another. The media can be used in the form of a stack of discs, or by wrapping the media around a perforated mandrel and eluting from one face to the other. The media can also be used in thin layer (paper) chromatography) for separation of soluble molecules. The result is a low cost, high speed chromatographic method for concentration and/or separation of substances, including biological particles. Its low cost allows it to be used as a disposable, thereby circumventing of the need to clean and recalibrate more expensive chromatographic devices.

While the foregoing has been set forth in considerable detail, it is to be understood that the examples and detailed embodiments are presented for elucidation and not limitation. Process and design variations, especially in matters of flowrate, eluent concentration, size and shape of the device and arrangements, may be made but are within the principles of the invention. Those skilled in the art will realize that such changes or modifications of the invention or combinations of elements, variations, equivalents, or improvements therein are still within the scope of the invention as defined in the appended claims and that the present invention may be suitably practiced in the absence of any limitation not explicitly described in this document.

We claim:

1. A chromatography column, comprising:
a housing having an inlet and an outlet and a chamber positioned therebetween; and
a stationary phase contained within said chamber, said stationary phase including a nano alumina medium, said medium comprising support fibers having attached thereto nano alumina fibers, said support fibers having a diameter greater than that of said nano alumina fibers.

2. The chromatography column as in claim 1 wherein said stationary phase is wrapped around a support means.

3. The chromatography column as in claim 1 wherein said support fibers are selected from the group consisting of microglass and lyocell.

4. The chromatography column as in claim 1 wherein said nano alumina medium further comprises sorbent particles that electrostatically adhere to said nano alumina fibers.

5. The chromatography column as in claim 4 wherein said sorbent particles are selected from the group consisting of metal oxides, silica, and titania.

6. The chromatography column as in claim 4 wherein said sorbent particles are negative ions.

7. The chromatography column as in claim 4 wherein said sorbent particles are biological particles.

8. The chromatography column as in claim 1 wherein said nano alumina medium further comprises third fibers.

9. A chromatography column, comprising:
a housing having an inlet, an outlet, and a chamber positioned therebetween;
a perforated support means axially positioned within said chamber; and
a stationary phase contained within said chamber and wrapped around said support means, said stationary phase including a nano alumina medium, said medium comprising support fibers having attached thereto nano alumina fibers, said support fibers having a diameter greater than that of said nano alumina fibers.

10. The chromatography column as in claim 9 wherein said support fibers are selected from the group consisting of microglass and lyocell.

11. The chromatography column as in claim 9 wherein said nano alumina medium further comprises sorbent particles electrostatically adhered to said nano alumina fibers.

12. The chromatography column as in claim 9 wherein said nano alumina medium further comprises third fibers.

13. A chromatography device, comprising:
a frame, and
a stationary phase supported by said frame, said stationary phase including a nano alumina medium, said medium comprising support fibers having attached thereto nano alumina fibers, said support fibers having a diameter greater than that of said nano alumina fibers.

14. The chromatography device as in claim 13 further comprising a conduction means for conducting an electrical potential across said stationary phase.

15. The chromatography device as in claim 14 wherein said electrical potential is applied in a plane that is transverse to a plane in which said stationary phase is positioned.

16. The chromatography device as in claim 13 wherein said stationary phase includes a plurality of layers of said nano alumina medium.

17. The chromatography device as in claim 13 wherein said support fibers are selected from the group consisting of microglass and lyocell.

18. The chromatography device as in claim 13 wherein said nano alumina medium further comprises sorbent particles electrostatically adhered to said nano alumina fibers.

19. The chromatography device as in claim 13 wherein said nano alumina medium further comprises third fibers.

20. A method of chromatographic separation of a sample into separate components comprising the steps of:
a. placing a sample into a chromatography column, said chromatography column having a nano alumina medium, said medium comprising support fibers having attached thereto nano alumina fibers, said support fibers having a diameter greater than that of said nano alumina fibers;
b. passing a mobile phase through said chromatography column; and
c. eluting said separated components from said nano alumina medium

21. The method of chromatographic separation as set forth in claim 20, further comprising the step of applying an electrical potential across said stationary phase to foster separation of components.

22. The method of chromatographic separation as set forth in claim 20, wherein said step of placing said sample is carried out by placing said sample through said column in a first direction and said step of passing said mobile phase is carried out by placing said mobile phase through said column in a second direction that is opposite to said first direction.

23. The method of chromatographic separation as set forth in claim 20, wherein said components are selected from the group consisting of water soluble molecules, dyes, pollutants, proteins, peptides, nucleic acids, viruses, bacteria, water soluble molecules, soluble dyes, RNA, DNA, oligonucleotides, enzymes, antibodies, and antigens.

24. The method of chromatographic separation as set forth in claim 20, wherein said mobile phase is selected from the group consisting of an aqueous solution, an inorganic salt solution, and a polar solvent.

25. The method of chromatographic separation as set forth in claim 20, wherein said step of eluting is performed at a pressure drop of less than about 10 bar.
